(19) United States
(12) Patent Application Publication
(10) Pub. No.: US 2020/0258542 A1
(43) Pub. Date: Aug. 13, 2020

(54) SYSTEMS AND METHODS FOR TRANSMITTING THEATER-BASED ANTI PIRACY IMAGES

(71) Applicant: University of North Texas, Denton, TX (US)

(72) Inventors: Scott H. Belshaw, Denton, TX (US); Michael Saylor, Richardson, TX (US)

(21) Appl. No.: 16/642,473

(22) PCT Filed: Sep. 5, 2018
(86) PCT No.: PCT/US18/49552

§ 371 Date: Feb. 27, 2020

Related U.S. Application Data
(60) Provisional application No. 62/554,997, filed on Sep. 6, 2017.
(60) Provisional application No. 62/594,370, filed on Dec. 4, 2017.

(51) Int. Cl. G11B 20/00; G06F 21/16; H04N 5/913; G03B 21/26; G03B 21/32

(52) U.S. Cl. CPC G11B 20/00884; G06F 21/16; H04N 2005/91392; G03B 21/26; G03B 21/32; H04N 5/913

(57) ABSTRACT

The present application relates to systems, methods, and computer-readable media for deterring video piracy. In aspects, a light source generates an infrared (IR) light spectrum that is projected onto a surface, such as a movie theatre screen. The IR light spectrum may form an watermark that is invisible to members of the audience that are viewing video content projected onto the surface, but that obfuscates at least a portion of video content captured by video recording device that is being used to capture a recording of the video content projected onto the surface. In aspects, a frequency of the IR light spectrum emitted by the light source may be periodically modified to make it more difficult to filter out the watermark.

### CROSS-REFERENCE TO RELATED APPLICATION

This application claims the benefit of U.S. Provisional Patent Application No. 62/554,997 entitled, “SYSTEM FOR LASER BASED THEATER ANTI PIRACY,” filed on Sep. 6, 2017, and U.S. Provisional Patent Application No. 62/594,370 entitled “SYSTEM FOR LASER BASED THEATER ANTI PIRACY,” filed on Dec. 4, 2017, the disclosures of which are expressly incorporated by reference herein in their entirety.

### TECHNICAL FIELD

The present application relates to systems and methods for deterring video piracy, and more particular to systems and methods for generating a light spectrum configured to create a watermark across at least a portion of recorded video content.

### BACKGROUND

Protection of intellectual property rights is a primary concern for content creators, such as the motion picture industry. However, there are many circumstances that make it difficult to protect those intellectual property rights. For example, many people bring recording devices into movie theaters and live shows to record the performance, then upload the recording to file sharing sites and/or sell copies of the recordings as a digital recording that may be downloaded and/or a hard copy format (e.g., a copy of the recording on a digital video disc (DVD) or Blu-Ray® disc. These criminal acts diminish the value of legitimate recordings. For example, content creators often release their content in movie theatres and derive revenue from their content through ticket sales at the movie theatre box offices. Additionally, content creators derive additional revenue through the sale of copies of their content in disc format, such as on DVD and Blu-Ray® discs. However, individuals who obtain illegally recorded copies of content often do not view the recorded content in movie theatres and/or do not purchase legitimate copies of the content in disc format. Thus, illegal recordings result in significant losses of revenue for the content creators through lost box office ticket sales and lost DVD and/or Blu-Ray® disc sales. Additionally, it is difficult to detect the individuals responsible for creating these illegal recordings. For example, in the United States alone there are over 35,000 theatre screens, and illegal recordings can be generated from any one of these locations, especially in view of advances made in handheld video recording devices, such as the miniaturization of video recording devices that are capable of recording high definition (HD) video.

### SUMMARY

The present application relates to systems, methods, and computer-readable media for deterring video piracy. In aspects, a light source generates an infrared (IR) light spectrum that is projected onto a surface, such as a movie theatre screen. The IR light spectrum may form an watermark that is invisible to members of the audience that are viewing video content projected onto the surface, but that obfuscates at least a portion of video content captured by video recording device that is being used to capture a recording of the video content projected onto the surface. In aspects, a frequency of the IR light spectrum emitted by the light source may be periodically modified to make it more difficult to filter out the watermark.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram illustrating aspects of an anti-piracy system in accordance with an embodiment of the present application; and

FIG. 2 illustrates a flow diagram of a method for reducing video piracy in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

“Sneak-cam” piracy refers to when a nefarious individual uses a video recording device to record content that he/she is otherwise not authorized to record. For example, such an individual may attend a movie being played at a theatre and use a video recording device to record the movie as it projected onto a movie screen. “Sneak-cam” piracy is often performed with intentions of releasing the recorded content via the Internet, either for free or for monetary gain. As described in more detail below, in embodiments, a watermark is drawn on a surface, such as a movie theatre screen, during presentation of content.

In embodiments, the watermark is dynamically generated and is invisible to the viewing audience, but is captured by a video recording device, such as would be used by an individual attempting to perform “sneak-cam” piracy. For example, Charged Coupled Devices (CCD) and Complementary Metal-Oxide-Semiconductor (CMOS) cameras have a wider light sensitivity band than the human eye, and are sensitive to the near infrared (nIR) portion of the light spectrum. Various devices have previously been proposed to overlay infrared (IR) patterns on screens or use IR flood-lights to drown out the content recorded by such cameras. Most of these previous systems used large, high-powered light arrays and were prohibitively expensive or required extensive modifications to the venue. Additionally, even when installed, these systems produced a static image that can be easily removed with IR filters, digital editing, and postproduction software that has become widely available. Due to such deficiencies, none of these systems have gained wide acceptance in the movie theater community. Instead, mitigation efforts by movie theatre operators typically involve detectives quipped with night vision equipment, which is expensive and time-consuming.

It is appreciated that while the following discussion is provided in the context of utilizing IR or nIR signals and sources to generate a watermark, the concepts described herein may be applied to any frequency range that is able to provide any form of interference to a camera attempting to pirate a video being displayed. For example, light in the ultraviolet (UV) range may be utilized in whole, or in part, with the following systems. Such UV light could be used to generate watermarks described herein, and/or to more generally generate interference or distortion to a recording device.

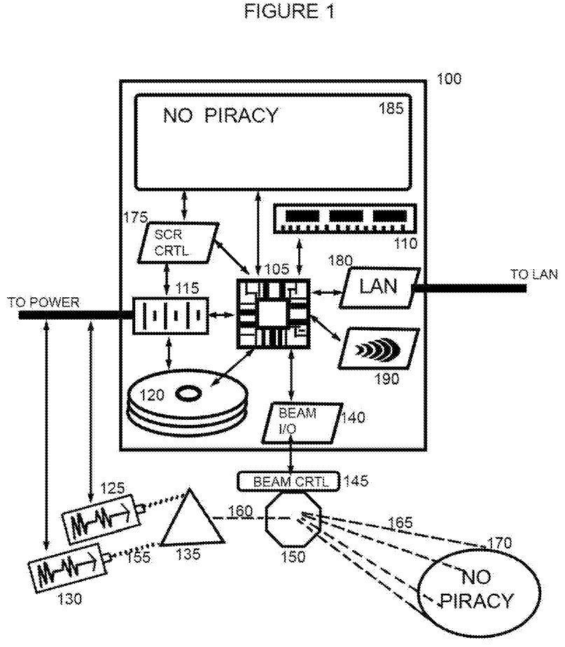

Referring to FIG. 1, a block diagram illustrating aspects of an anti-piracy system in accordance with embodiments is shown as a system 100. As shown in FIG. 1, the system 100 includes one or more processors 105, a memory 110, a power supply 115, a database 120, a first light source 125, a second light source 130, a beam combiner 135, a beam director unit (BDU), a screen controller 175, a display screen 185, a communication interfaces 180,190.

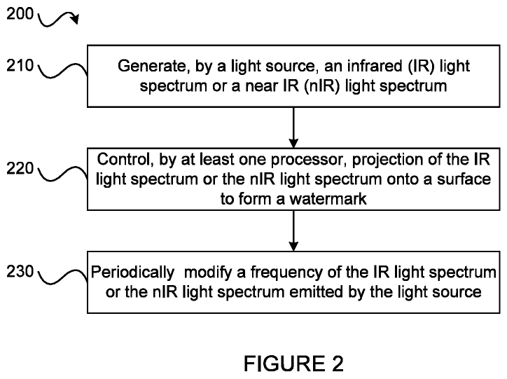

In aspects, the one or more processors 105 may be configured to receive inputs from a user and to generate commands to control the operations of the system 100 to generate watermarks in accordance with embodiments, as described in more detail below. In aspects, the one or more processors 105 may include a real time clock. In aspects, the memory 110 may include random access memory (RAM), dynamic RAM (DRAM) devices, static RAM devices, one or more hard disk drives (HDDs), flash memory devices, solid state drives (SSDs), other devices configured to store data in a persistent or non-persistent state, or a combination of different memory devices. In aspects, the memory 110 may store instructions that, when executed by the one or more processors 105, cause the one or more processors 105 to perform the operations described in connection with the system 100 with reference to FIGS. 1 and 2, as described in more detail below.

In aspects, power supply 115 may be configured to draw operational power from an external power source. For example, in aspects, power supply 115 may be plugged into a wall outlet and may draw operational power from a 110V AC wall plug. It is noted that the particular characteristics of the power source (e.g., 110V AC power) have been provided for purposes of illustration, rather than by way of limitation, and that embodiments are not to be limited to certain characteristics of the utilized power source. Additionally, in aspects, the power supply 115 may include a primary power supply and a secondary power supply. For example, the primary power supply may be configured to draw operational power from an external power source, such as an electrical outlet, and the secondary power supply may include a battery that is configured to provide operational power in the event that the primary power supply fails. By providing the secondary power supply, a likelihood that the system 100 may be rendered ineffective in reducing video piracy is greatly decreased. For example, unplugging the primary power supply in an attempt to prevent the generation of the watermark would fail because operational power can be drawn from the secondary power source (e.g., the battery). In aspects, the secondary power supply may be charged during time periods when the system 100 is plugged in to an external power source.

In aspects, the first light source 125 may be an infrared (IR) or near IR (nIR) light source configured (or other usable frequency, such as UV) to emit an IR light spectrum or nIR light spectrum. In aspects, the second light source 130 may be a light source configured to emit light within the visible light spectrum, such as a visible laser light source. In aspects, the second light source 130 may be utilized to calibrate the first light source 125. For example, the second light source 130 may be used to determine locations where the watermarks generated by the first light source 125 will be located.

In aspects, the beam combiner 135 may be configured to align the beams of light, illustrated at 155, emitted by both the first light source 125 and the second light source 130 such that the respective beams of light are co-axial before they are provided to the BDU. The BDU may include a beam director 140, a beam controller 145, and a beam actuator 150. The beam director 140 may be configured to interface with the one or more processors 105, such as to receive control signaling from the one or more processors 105, and to interpret the control signaling received from the one or more processors 105 and convert the control signaling received from the one or more processors 105 into control data configured to manage and direct the light emitted by the first light source 125 and/or the second light source 130. The beam controller 145 may be configured to convert the control data received from the beam controller 140 into signals that directly drive a beam actuator 150 to control the direction of the light emitted by the first light source 125 and/or the second light source 130. For example, in aspects, the beam actuator 150 may be configured to receive, as shown at 160, the beams of light and turn them into deflected beams of light. In aspects, the beam actuator may include piezo-electric steered mirrors, micro-servo steered mirrors, or optically active prisms that utilize electric impulses to change the index of refraction of the components to bend the beam. In aspects, regardless of which technology is used to implement the beam actuator 150, this element may rapidly move the beams of light emitted by the first light source 125, the second light source 130, or both, back and forth to generate the watermark. For example, after the beams of light are processed by the beam actuator, the beams of light are spread out or are “dithered” into a fan or cone, as shown at 165, to cover an area of a surface, such as wall or screen. When the dithered beam is reflected off the surface, the persistence of vision phenomenon causes the appearance of a watermark, as shown at 170, which may appear as continuous lines, forms, or text.

In aspects, the beam controller 140 may be configured to convert a desired watermark, as may be configured using the screen control module 175, into a vector format using a coordinate transform system, and the beam controller 145 may be configured to convert the vector information into beam steering directions that can be sent to the beam actuator 150. The one or more light sources, such as the light source 125 may be controlled by the beam actuator 150 and projected onto a surface, such as wall or screen, creating the watermark of text, shapes, and/or graphics.

In aspects, the watermark may include a graphic, text, shape, interference signal, or combination thereof which is able to distort a video captured by a pirate device. For example, the watermark may be formed as a rectangle or other shape that covers a portion of the surface upon which the watermark is projected, such as a movie theatre screen. As another example, the watermark may be formed as text, such as a message, that covers a portion of the surface upon which the watermark is projected, such as a movie theatre screen. As another example, the watermark may be formed as a graphic, such as a logo, that covers a portion of the surface upon which the watermark is projected, such as a movie theatre screen. In aspects, the watermark may include information that identifies a location of venue, such as a movie theatre's address or other identifier, a theatre identifier, such as theatre 1 (for movie theatres that include multiple screens), timestamp information associated with a particular showing of visual content, such as a movie, and other information that may be used to identify the particular location where content was nefariously recorded. In aspects, the watermark may appear as an interference signal that distorts or blurs the underlying video. As briefly explained above, because the watermark is produced using an electromagnetic signal, such as nIR and/or IR beams of light, the watermark may not interfere with the viewing experience of members in the audience, but may visually obfuscate portions of content recorded during presentation of the content while the watermark is present. For example, in the context of a movie theatre, the watermark may be invisible to the audience viewing the movie, but any recording generated from the presentation of the movie would have at least a portion of the video content obfuscated due to the presence of the watermark. In this manner, the nefarious recording would be of low quality and of little interest to individuals that typically seek to acquire access to “sneak-cam” type video content.

In aspects, the screen controller 175 may be configured to enable a user to manage and configure the watermark. For example, the screen controller 175 may be stored as instructions that, when executed by the one or more processors 105, cause the one or more processors 105 to provide a graphical user interface that enables the user to configure the text, shapes, graphics, etc. that will be represented by the watermark, and to configure the location(s) where the watermark will be projected onto the surface. In aspects, once the watermark is configured, the user may utilize the visible beam generated by the second light source 130 to adjust the height and width of the watermark to ensure that it is appearing in the correct place and in the correct size and orientation. If desired, the watermark may also be set to “track” or “float” around the surface to ensure it cannot easily be removed by masking or with postproduction software. Once the user is satisfied with the watermark's configuration, the first light source 125 may be activated and the second light source 130 may be deactivated, making the watermark invisible to the human eye.

In aspects, the system 100 may include communication interfaces, such as a local area network (LAN) communication interface 180 and a wireless communication interface 190. The communication interfaces 180, 190 may facilitate communication with other devices over wired and/or wireless connections. In aspects, the one or more processors 105 may be configured to generate one or more alerts based on an operational status of the system, and to transmit the one or more alerts to a remote device via the network. For example, the one or more processors 105 may be configured to generate alerts when various operational events occur, such as when a component fails (e.g., a light source, a power source, etc.), and the alerts may be communicated to one or more desired receiving devices, such as an e-mail address of a manager of the movie theatre, for example.

As shown in FIG. 1, the system 100 includes display device 185. The display device 185 may be configured to display information to a user, such as during a process to configure the watermark. In aspects, the display device 185 may be located remote from the system 100, and may enable a user to configure various operational parameters for the watermark and/or system 100 through a wired or wireless connection to the system 100. In other aspects, the display device 185 may be integrated with a housing that encloses one or more components of the system 100.

In aspects, the system 100 may be integrated with a projection device, such as a movie projector. In additional aspects, the system 100 may be provided as stand-alone device that is placed in proximity of a projection device. For example, in aspects, the system 100 may be enclosed within a housing that is approximately the size of a shoe box, and may be placed above or next to a projector that is used to present movies in a movie theatre. In additional aspects, the system 100 (or portions thereof, such as light sources in communication with other control circuitry) may be mounted on a wall within a movie theatre at a location that enables the watermark to be projected onto a surface, such as the movie screen. In aspects, the system 100 may include one or more additional light sources (not shown in FIG. 1) configured to generate a visible, nIR, and/or IR light spectrum. These additional light sources may be collocated with the light sources 125, 130, or may be located remote from the light sources 125, 130. In further aspects, light sources may be mounted in a manner that the interference source is projected directly back at a recording device (e.g. without reflecting off of the screen).

In aspects, the one or more processors 105 may be configured to periodically modify a frequency of the electromagnetic signals. For example, one or more processors 105 may be configured to periodically modify the frequency of the IR light spectrum or the nIR light spectrum emitted by the first light source 125 and/or any other light sources emitting light spectrums. This may decrease the ability to filter out the watermark using lens filters or other filtering techniques. In aspects, the system 100 may include a randomization engine configured to generate an output that is used by the one or more processors 105 to randomly modify the frequency of the light spectrum used to generate the watermark. In aspects, rather than including a randomization engine, the information stored at the database 120 may also include watermark timing information, and the one or more processors may be configured to periodically modify the frequency of the IR light spectrum or the nIR light spectrum emitted by the first light source 125 based on the timing information.

In aspects, the one or more processors 105 may be configured to record information associated with an operational status of the system at the database 120. For example, the one or more processors 105 may log each movie that was shown in a particular theatre, the start time and an end time for the movie, a start time for when projection of the watermark was initiated and an end time for when the projection of the watermark was stopped, as well as other operating conditions, such as times when the primary power source failed and the secondary power source was activated to provide operational power to the system 100, or other operating conditions. The ability to dynamically generate text in real time and have a current date/time stamp on any pirated recording can assist law enforcement in catching movie pirates with the aid of ticket purchase records for a particular show, narrowing down the possible suspects.

In aspects, the database 120 may store watermark location information, and the one or more processors 105 may be configured to generate the one or more signals configured to form the watermark based on the location information. For example, when a user configures the watermark using the screen control module 175, watermark parameters, such as the contents of the watermark (e.g., graphics, shapes, and/or text) and/or location of the watermark, may be stored at the database 120.

As shown above, the system 100 provides a compact system that includes supporting software for creating user-customizable watermarks that may be converted into vector instructions by the drive Beam Director Unit (BDU) to project the watermarks onto a surface. The dynamically generated watermarks are displayed and may be moved relative to the surface upon which they are projected, providing a more robust system for deterring video piracy and other unauthorized video records as compared to other systems designed for similar purposes. Additionally, by periodically modifying the frequency of the light spectrum emitted by the first light source 125 (and/or other light sources in multi-light source deployments), system 100 is capable of thwarting the efforts of nefarious individuals who were previously able to use special filters, such as IR notch filters, to filter out the watermarks of prior systems. Additionally, because the system 100 of embodiments can be provided in a small form factor, it may be located within a movie theatre of other venue in a manner that is non-intrusive, as compared to existing systems, which are bulky and are typically required to be placed proximate the surface upon which the watermark is to be projected.

Referring to FIG. 2, a flow diagram of a method for reducing video piracy in accordance with an embodiment of the present application is shown as a method 200. Again, it is appreciated that method 200 is described in the context of an IR or nIR source, but any electromagnetic frequency that can function to provide disruption to pirating devices may be utilized with the present systems and methods. At 210, the method 200 includes generating, by a light source, an infrared (IR) light spectrum or a near IR (nIR) light spectrum. At 220, the method 200 includes controlling, by at least one processor, projection of the IR light spectrum or the nIR light spectrum onto a surface to form a watermark, and, at 2320, periodically modifying a frequency of the IR light spectrum or the nIR light spectrum emitted by the light source. In aspects, the method 200 may include additional operations describe above with reference to FIG. 1, such as converting a desired watermark into a vector format using a coordinate transform system, and then converting the vector information into beam steering directions than are used to control projection of the emitted beams of light to project the watermark onto the surface, such as wall or screen, creating the watermark of text, shapes, and/or graphics. In aspects, the method 200 may be stored as instructions (e.g., the instructions stored at the memory 110 of FIG. 1, that, when executed by one or more processors (e.g., the one or more processors 105 of FIG. 1), cause the one or more processors to perform the operations of the method 200.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A system comprising:
a light source configured to emit an infrared (IR) light spectrum or a near IR (nIR) light spectrum;
at least one processor configured to:
generate one or more signals configured to control projection of the IR light spectrum or the nIR light spectrum onto a surface to form a watermark; and
periodically modify a frequency of the IR light spectrum or the nIR light spectrum emitted by the light source; and
a memory communicatively coupled to the at least one processor.

2. The system of claim 1, further comprising a beam director unit coupled to the light source and configured to modify, responsive to the one or more signals generated by the at least one processor, a direction of projection for the IR light spectrum or the nIR light spectrum.

3. The system of claim 2, wherein modifying the direction of projection modifies at least one characteristic of the watermark.

4. The system of claim 3, wherein the at least one characteristic of the watermark comprises at least one of a shape of the watermark, a size of the watermark, and a location of the watermark.

5. The system of claim 1, further comprising one or more additional light sources configured to emit an IR light spectrum or a nIR light spectrum, wherein at least a portion of the watermark is formed based on the IR light spectrum or the nIR light spectrum emitted by at least one of the one or more additional light sources responsive to signaling generated by the at least one processor.

6. The system of claim 5, further comprising one or more additional steering devices, wherein each of the one or more additional steering devices is coupled to one of the one or more additional light sources and is configured to modify, responsive to signaling generated by the at least one processor, a direction of projection for the IR light spectrum emitted by each of the one or more additional light sources.

7. The system of claim 1, further comprising a primary power supply and a secondary power supply, wherein the primary power supply is configured to draw operational power from an external power source, and wherein the secondary power supply comprises a battery.

8. The system of claim 1, further comprising a second light source configured to emit a visible light spectrum.

9. The system of claim 8, wherein the visible light spectrum emitted by the second light source is configured to calibrate a position of the light source, the watermark, or both.

10. The system of claim 1, further comprising a communication interface configured to communicatively couple the at least one processor to a network, wherein the at least one processor is configured to:
generate one or more alerts based on an operational status of the system; and
transmit the one or more alerts to a remote device via the network.

11. The system of claim 1, wherein the surface comprises a theatre screen, and wherein the watermark is configured to obfuscate at least a portion of video content projected onto the theatre screen by a projector when recorded by a video recording device.

12. The system of claim 11, wherein the light source is integrated with the projector.

13. The system of claim 11, wherein the at least one processor is configured to synchronize a location of the watermark to particular regions of the theatre screen.

14. The system of claim 1, wherein the watermark comprises a graphic, text, a shape, or a combination thereof.

15. The system of claim 1, further comprising a database, wherein the at least one processor is configured to record information associated with an operational status of the system at the database.

16. The system of claim 15, wherein the database stores watermark location information, and wherein the processor is configured to generate the one or more signals configured to form the watermark based on the location information.

17. The system of claim 15, wherein the database stores watermark timing information, and wherein the processor is configured to periodically modify the frequency of the IR light spectrum or the nIR light spectrum emitted by the light source based on the timing information.

18. The system of claim 1, further comprising a randomization engine, wherein the processor is configured to periodically modify the frequency of the IR light spectrum or the nIR light spectrum emitted by the light source based on an output of the randomization engine.

19. A method comprising:
generating, by a light source, an infrared (IR) light spectrum or a near IR (nIR) light spectrum;
controlling, by at least one processor, projection of the IR light spectrum or the nIR light spectrum onto a surface to form a watermark; and
periodically modifying a frequency of the IR light spectrum or the nIR light spectrum emitted by the light source.

20. A non-transitory computer-readable medium storing instructions that, when executed by one or more processors, cause the one or more processors to perform operations comprising:
emitting an infrared (IR) light spectrum or a near IR (nIR) light spectrum from a light source;
controlling projection of the IR light spectrum or the nIR light spectrum onto a surface to form a watermark; and
periodically modifying a frequency of the IR light spectrum or the nIR light spectrum emitted by the light source.

21. A system comprising:
a light source configured to emit an electromagnetic signal;
at least one processor configured to:
generate one or more signals configured to control projection of the emitted signal onto a surface to form a watermark; and
periodically modify a frequency of the electromagnetic signal emitted by the light source; and
a memory communicatively coupled to the at least one processor.

22. The system of claim 2 wherein the watermark provides an interference signal which distorts underlying video displayed on the surface when observed through a capture device.
